(19) United States
(12) Patent Application Publication
(10) Pub. No.: US 2025/0376832 A1
(43) Pub. Date: Dec. 11, 2025

(54) WATER MONITORING AND MANAGEMENT SYSTEM IN DISTRIBUTION NETWORKS

(71) Applicant: ECOVA ENVIRONNEMENT, Franconville La Garenne (FR)

(72) Inventors: David ALVES, Saint Gratien (FR); Fátima CARDOSO ALVES, Saint Gratien (FR)

(21) Appl. No.: 18/876,483

(22) PCT Filed: May 31, 2023
(86) PCT No.: PCT/IB2023/055587

§ 371 Date: Dec. 18, 2024

(30) Foreign Application Priority Data
Jun. 20, 2022 (PT) 118052

(51) Int. Cl. E03B 7/07; G01F 15/18

(52) U.S. Cl. CPC E03B 7/072; E03B 7/078; G01F 15/18

(57) ABSTRACT

An individual water consumption monitoring and management system, applicable in domestic, commercial and industrial water distribution networks. One of the preferred ways of implementing the proposed system comprises the development of two solutions. The first solution comprises the use of multiple flow meters, enabling the individual measurement of water consumption from the domestic, commercial or industrial network where the system is implemented, and the second solution comprises the use of a single flow meter, for measuring consumption, associated with at least one pressure sensor which is adapted to identify the water dispenser circuit that is active.

### TECHNICAL FIELD

The present invention describes an individual water consumption monitoring and management system, applicable in domestic, commercial and industrial water distribution networks.

### BACKGROUND

Water has always been one of the basic needs for human survival, and it is becoming increasingly necessary to monitor its consumption to allow a thoughtful and responsible use of this resource.

Using water consumption monitoring systems, it is possible to measure, in real time, the amount of water consumed in the most diverse and varied situations. Most existing systems make it possible to cumulatively reduce losses caused by catastrophic ruptures that occur in sanitary water circuits, promoting the automatic or remote closing of safety valves. Many of the systems also make it possible to identify and react autonomously to small leaks in tap circuits or in other locations in the hydraulic circuits. However, none of the technologies known today allows for the generic and effective monitoring of water supply networks, predicting the existence of possible leaks or rupture points therein.

### SUMMARY

The present application describes a system for monitoring and managing water consumption in interior house supply networks, comprising at least one flow meter installed in the interior water supply network; and at least one control system configured to receive data from the at least one flow meter; characterized in that the control system transmits the data received from the at least one flow meter to a server by means of a wireless communication system and also displays them to a user by means of an LCD screen.

In a proposed embodiment, the control system comprises at least a microcontroller and a current converter.

In yet another embodiment, the interior house water supply network comprises at least one division provided with a distribution box that branches the interior supply network through a set of valves.

In yet another embodiment, the interior house water supply network comprises at least one cold water network and one hot water network.

In yet another embodiment, the branching of the internal supply network by a set of valves comprises circuits that independently feed each of said valves and which comprise the installation of at least one flow meter in each of said circuits.

In yet another embodiment, each distribution box comprises at its inlet at least one cold water network and at least one hot water network under which flow meters are individually installed.

In yet another embodiment, each of the distribution boxes comprises decentralized control assemblies comprising at least one microcontroller configured to collect and analyse data from at least one flow meter.

In yet another embodiment, the decentralized control assemblies remotely communicate with the control system by means of a wireless communication system.

In yet another embodiment, the system for monitoring and managing water consumption in interior house supply networks comprises a measuring device composed of a flow meter and a pressure transducer, which are internally connected to a microcontroller configured to collect and analyse the data resulting thereof.

In yet another embodiment, the system for monitoring and managing water consumption in interior house supply networks comprises a monitoring device composed of a server configured to collect, by means of wireless communication networks, data from a measuring device, and by at least one configured microcontroller and LCD display configured to display the information to a user.

In yet another embodiment, the server is configured to provide information to a user by means of a user device, for example a smartphone or other technically suitable device.

In yet another embodiment, the flow meter comprises at least two inner service pipes, a first service pipe and a second service pipe, under which at least one interior flow meter is installed independently, and in each of said service pipes.

In yet another embodiment, the at least two inner service pipes of the flow meter comprise equal sections.

In yet another embodiment, the at least two inner service pipes of the flow meter comprise different sections.

In yet another embodiment, at least one of the two inner service pipes of the flow meter comprises a non-return valve configured to prevent flow from occurring in the flow meter installed in series in the respective service pipe.

In yet another embodiment, at least one of the two inner service pipes of the flow meter comprises more than one flow meter mounted in series on the service pipe.

### BRIEF DESCRIPTION

The present invention describes an individual water consumption monitoring and management system in domestic, commercial and industrial distribution networks.

The purpose of this system is to provide control and monitoring mechanisms of the water supply networks to users, guaranteeing and optimizing the management of water resources, as well as predicting the existence of possible leaks in said installations.

Since flow meters allow the measurement of liquid or gaseous flow rates, their selection and incorporation in the present system guarantees their suitability for the measurement of fluid flow rates with viscosities typical of water. In a preferred embodiment of this system, the equipment that forms part thereof guarantees its operability for pressures equal to or greater than 6 bars, in order to guarantee compliance with existing regulations related to public water distribution systems.

Regarding the flow rate sensors used in the present system, one of its main characteristics is the measurement range, which is selected according to the service pipe of the pipeline to which it will be associated. If a flow meter is associated with multiple dispensers (water distribution/supply circuits), its sizing should take into account the sum of the corresponding typical flow rates in each of said circuits. By way of example, the typical flow rates for some of the existing elements in a domestic distribution network are presented below: Kitchen sink (12 L/min), Washbasin (6 L/min), Bidet (6 L/min), Shower (12 L/min), Bathtub (24 L/min), flushing cistern (6 L/min), Washing machine (12 L/min), Dishwasher (12 L/min).

The present system aims at a diversified application in different types of dwellings. As an example, we will consider the application of the system in a single-family house, which includes, for example, a kitchen, a common room, three bedrooms, a complete bathroom and an auxiliary bathroom for the kitchen and living room. It is considered that in the solutions presented:
the complete bathroom includes a washbasin, a bathtub, a bidet and a toilet;
the auxiliary bathroom includes a washbasin and a toilet;
the kitchen includes a sink, a dishwasher and a washing machine;
the reference house has a plumbing installation with distribution boxes.

With regard to the definition of plumbing with distribution boxes, it comprises a cold water service pipe and a hot water service pipe (when applicable) which are routed to each of the previously mentioned divisions. In each of these divisions, there is a junction box where the inlet service pipes are distributed to the various water dispensers. The use of a distribution box for each of the divisions where there are several water dispensers (taps, showers, flushing cisterns and dishwashers or washing machines) is a common practice in the construction of buildings, and is currently widely used. Distribution boxes, pipes and a wide range of accessories that can be used in domestic plumbing are widely available on the market.

The present application also describes technologies associated with the development of a combined flow meter, which has wider measurement ranges. This development comes from the fact that measuring equipment is widely used nowadays in experimental devices and/or in industrial and domestic applications. However, it appears that the measurement fields of most equipment depend on the grades to be measured and the technologies used.

Most measuring equipment is characterized by a nominal value, and other standard values, such as the minimum and maximum measurement limits, which define its measurement range. The nominal value normally corresponds to conditions of good overall performance of the measuring equipment. The ratio between the maximum and minimum limits depends on the quantity to be measured and the technology used. Thus, in some equipment the ratio between the maximum and minimum measurement values can be up to four, and in other cases, this ratio can be very large, or even tend to infinity, particularly when the minimum measurement value is zero. However, in many devices the minimum and maximum measurement limits tend to be somewhat proportional, which means that when there is a need to increase a maximum measurement limit, the corresponding minimum limit also tends to increase in inverse proportion. When in certain applications it is intended to measure very small values and also very large values, difficulties sometimes occur. One of the ways to make measurements at very wide intervals or measurement ranges is often the use of several measurement circuits. Under such conditions, the most suitable measurement circuit is selected for the value that is actually intended to be measured with greater precision. However, switching between measuring circuits is not particularly practical. It is also found that this switching between measurement circuits tends to introduce disturbances, which can be inconvenient. In the particular case of measuring flow rates in liquids or gaseous substances, switching between circuits introduces some difficulties. Effectively, switching between circuits in this type of application requires opening and closing valves in a sequence that can be more or less complex. It is also verified that in many of the measuring equipment of this nature, the accuracy of the readings tends to be better in the final ⅔ of the established measuring range. Measurements close to the minimum limit tend to have low accuracy. Thus, flow rate measurement tends to present difficulties, both in accuracy and in measurement ranges, tending to present relatively small measurement intervals, and in many cases, large minimum measurement values. The good effective accuracies of flow meters are also usually only available in a small measurement range within the general measurement range. In flow rate measurement, the use of different technologies is known, namely: turbine; float; vortex; pressure difference, transit time, ultrasonic Doppler and electromagnetic flow meters. Some of the flow rate measurement technologies can only be used when fluids have very particular characteristics, as in the particular case of electromagnetic and ultrasonic flow meters that cannot be used to measure flow rates of most pure substances. Turbine flow meters are relatively inexpensive and suitable for measuring flow rates in most existing applications. However, they have limitations related to the accuracy of their measurements and which are related to the fact that the ratio between the maximum and minimum flow rates is relatively small, and the ratio value of 20 can be taken as a reference. A turbine flow meter with a maximum flow rate of 20 litres per minute will have a minimum flow rate of 1 litre per minute. Under these conditions, flow rates below 1 litre per minute will not be measured by the flow meter. This particularity represents an important limitation related to the measurement range of turbine flow meters, a limitation that is even more pronounced in other flow rate measurement technologies.

Considering the previously identified limitations, the present invention also discloses an architecture and/or combination of flow meters that globally works within a consolidated unit that promotes an extended measurement range. In the configuration herein suggested, at least two flow meters are used in adjacent reading service pipes whose measurement intervals overlap in a certain range of values. The flow meters are configured to ensure that the minimum measurement limit of the first flow meter is slightly less than the maximum limit of the second flow meter. Under these conditions, and with the appropriate choice of the remaining characteristics of the measurement circuit, a combined flow meter is obtained whose minimum measurement limit corresponds to the minimum limit of the first flow meter and the maximum limit corresponds to the sum of the maximum limits of the two flow meters used.

According to the internal architecture presently described, the combined flow meter will therefore make it possible to extend the actual measurement ranges. The measurement range will correspond to the combination of the measurement ranges of the internal flow meters used. Under these conditions, the ratio between the maximum and minimum flow rates of the combined flow meter tends to be the product of the corresponding values of the internally incorporated flow meters. As it is a passive solution, it overcomes the underlying problem of the need to switch between measurement circuits, a characteristic that makes it particularly innovative and technically relevant in certain solutions, in particular when integrated into monitoring systems and individual management of water consumption.

### BRIEF DESCRIPTION OF THE FIGURES

For an easier understanding of the present application, figures are herein attached, which represent embodiments which however are not intended to limit the art herein disclosed.

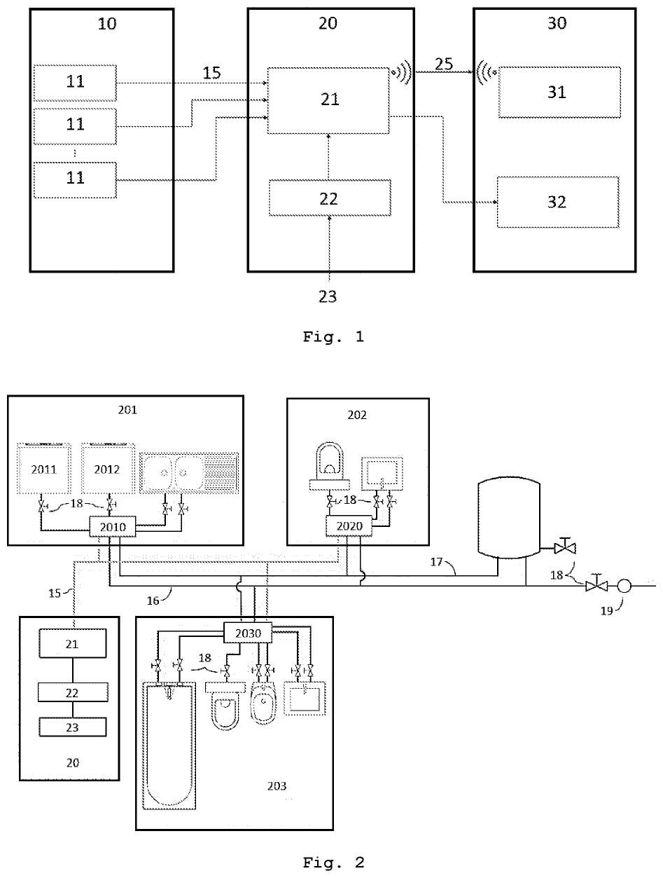

FIG. 1 schematically illustrates an embodiment of the present invention, i.e., the water monitoring and management system in distribution networks, wherein the reference numbers represent:
10—water inlet of the distribution network;
11—flow meters;
15—analogue signal;
20—control system;
21—microcontroller;
22—AC-DC current converter;
23—electrical network;
25—wireless connection for data transfer;
30—output values;
31—server;
32—LCD screen.

FIG. 2 illustrates an embodiment of the water monitoring and management system applied in distribution networks, in the particular case of a house, wherein the reference numbers represent:
201—kitchen;
2010—distribution box C;
2011—washing machine;
2012—dishwasher;
202—auxiliary bathroom;
2020—distribution box B;
203—complete bathroom;
2030—distribution box A;
15—analogue signal;
16—cold water network;
17—hot water network;
18—valve/tap;
19—water meter;
20—control system;
21—microcontroller;
22—AC-DC current converter;
23—electrical network.

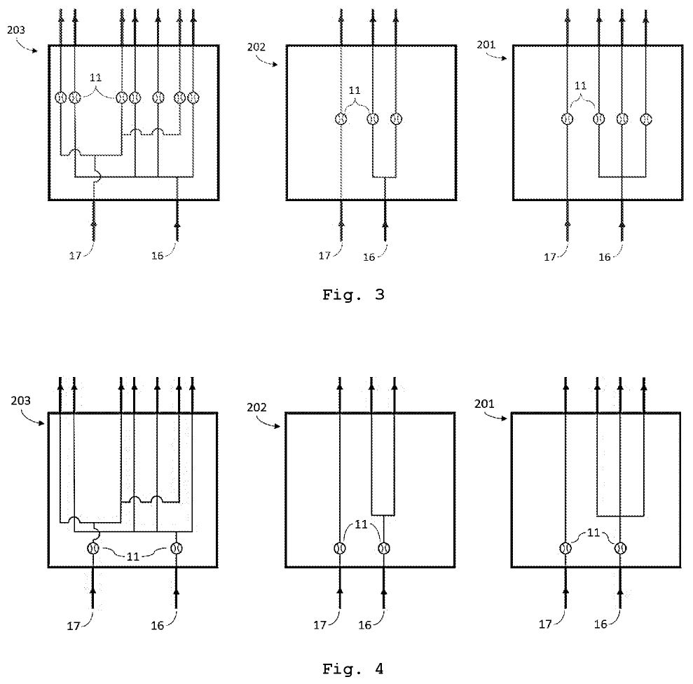

FIG. 3 illustrates an embodiment of the water monitoring and management system applied in distribution networks, in the particular case of a house, wherein the reference numbers represent:
201—kitchen;
202—auxiliary bathroom;
203—complete bathroom;
11—flow meter;
16—cold water network;
17—hot water network.

FIG. 4 illustrates a complementary embodiment of the water monitoring and management system applied in distribution networks, in the particular case of a house, wherein the reference numbers represent:
201—kitchen;
202—auxiliary bathroom;
203—complete bathroom;
11—flow meter;
16—cold water network;
17—hot water network.

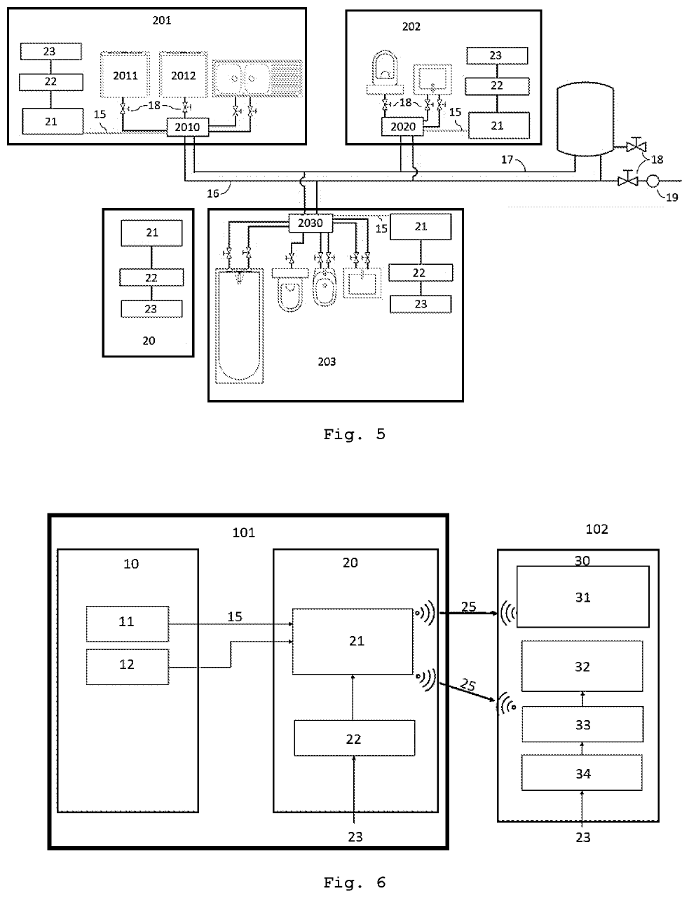

FIG. 5 illustrates a complementary embodiment of the water monitoring and management system applied in distribution networks, in the particular case of a house, wherein the reference numbers represent:
201—kitchen;
2010—distribution box C;
2011—washing machine;
2012—dishwasher;
202—auxiliary bathroom;
2020—distribution box B;
203—complete bathroom;
2030—distribution box A;
15—analogue signal;
16—cold water network;
17—hot water network;
18—valve/tap;
19—water meter;
20—control system;
21—microcontroller;
22—AC-DC current converter;
23—electrical network.

FIG. 6 schematically illustrates another proposed embodiment for the present invention, i.e., the system for monitoring and managing water in distribution networks, wherein the reference numbers represent:
101—measuring devices;
102—monitoring devices;
10—water inlet from the distribution network;
11—flow meters;
12—pressure transducer;
15—analogue signal;
20—control system;
21—microcontroller;
22—AC-DC current converter;
23—electrical network;
25—wireless connection for data transfer;
30—output values;
31—server;
32—LCD screen;
33—microcontroller;
34—AC-DC current converter;
23—electrical network.

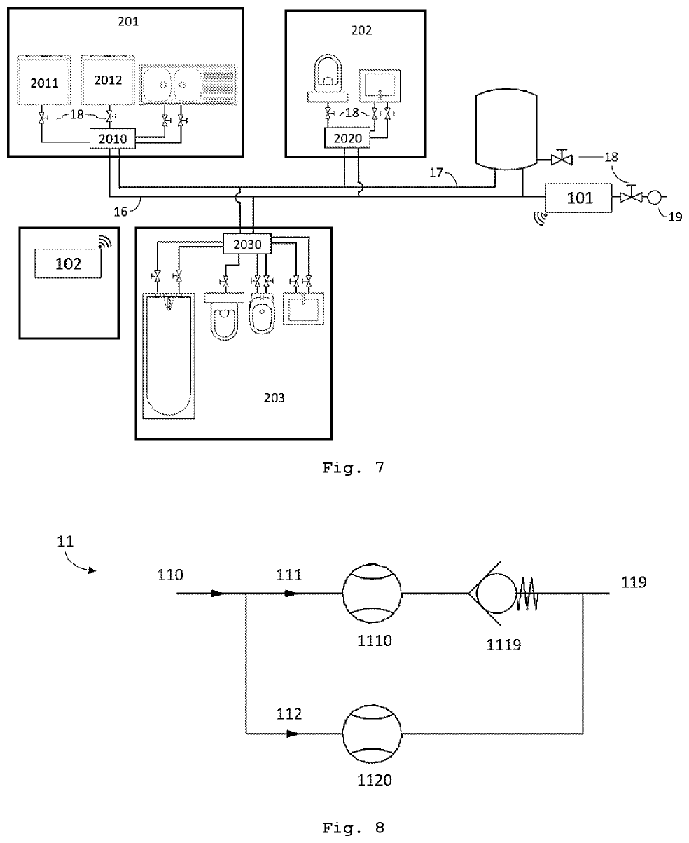

FIG. 7 illustrates another embodiment proposed for the water monitoring and management system applied in distribution networks, in the particular case of a house, wherein the reference numbers represent:
201—kitchen;
2010—distribution box C;
2011—washing machine;
2012—dishwasher;
202—auxiliary bathroom;
2020—distribution box B;
203—complete bathroom;
2030—distribution box A;
16—cold water network;
17—hot water network;
18—valve/tap;
19—water meter;
101—measuring devices;
102—monitoring devices.

FIG. 8 illustrates another embodiment proposed for the water monitoring and management system applied in distribution networks, in the particular case of a house, wherein the reference numbers represent:
11—flow meter;
110—combined flow meter water inlet;
111—first service pipe;
112—second service pipe;
119—combined flow meter water outlet;
1110—first internal flow meter of the first service pipe;
1119—first service pipe non-return valve;
1120—first internal flow meter of the second service pipe.

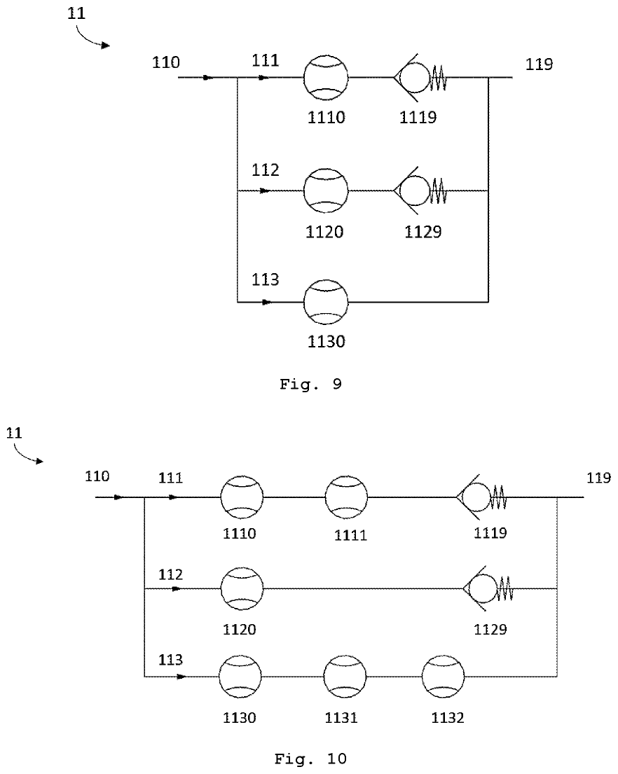

FIG. 9 illustrates another embodiment proposed for the water monitoring and management system n applied in distribution networks, in the particular case of a house, wherein the reference numbers represent:
11—flow meter;
110—combined flow meter water inlet;
111—first service pipe;
112 second service pipe;
113—third service pipe;
119—combined flow meter water outlet;
1110—first internal flow meter of the first service pipe;
1119—first service pipe non-return valve;
1120—first internal flow meter of the second service pipe;
1129—second service pipe non-return valve;
1130—first internal flow meter of the third service pipe.

FIG. 10 illustrates another embodiment proposed for the water monitoring and management system applied in distribution networks, in the particular case of a house, wherein the reference numbers represent:
11—flow meter;
110—combined flow meter water inlet;
111—first service pipe;
112—second service pipe;
113—third service pipe;
119—combined flow meter water outlet;
1110—first internal flow meter of the first service pipe;
1111—second internal flow meter of the first service pipe;
1119—first service pipe non-return valve;
1120—first internal flow meter of the second service pipe;
1129—second service pipe non-return valve;
1130—first internal flow meter of the third service pipe;
1131—second internal flow meter of the third service pipe;
1132—third internal flow meter of the third service pipe.

### DESCRIPTION OF THE EMBODIMENTS

Referring to the figures, some embodiments are now described in more detail, which are not intended, however, to limit the scope of the present application.

The first solution of the system herein disclosed comprises the use of multiple flow meters (11), enabling individual measurement and accounting of water consumption in the distribution network where the system is implemented. Thus, the first solution comprises the use of a flow meter (11), by installing it in each of the outlet service pipes inside each distribution box of the house (2010, 2020, 2030), both in the cold water outlets (16) and well in the hot water outlets (17). In this way, it is possible to monitor the amount of water used in each of the dispensers, as well as to account for the consumption of cold and hot water. The interpretation and processing of data, recorded in each of the installed flow meters (11), will be carried out with the aid of a microcontroller (21).

Connecting the microcontrollers (21) to a tactile screen (32) allows not only the processing of the collected data to display the respective consumptions in real time, but also allows the determination of the cumulative consumptions related to certain periods. These data are also likely to be communicated to a remote server (31) by means of a wireless connection, for example Wi-Fi (25), which will guarantee the storage thereof, and enable the remote access thereof, for example, through a mobile application, allowing interaction with the user. FIG. 1 illustrates a possible diagram of the physical electrical connections and wireless communications between the different elements of the first solution.

FIG. 2 illustrates the general arrangement of the various elements relevant to the implementation of the first solution proposed for the system. Three divisions are herein represented with the respective water dispensing elements, as well as a possible location of the control equipment. The implementation of this solution requires the passage of data transmission cables (15) between the flow meters (11) and the microcontroller (21). In order not to introduce aesthetic disturbances related to the passage of cables, this first solution requires its installation during the construction of the house infrastructure.

Alternatively, and to minimize the constructive limitations of using a structured cable network for data transmission, communication using wireless networks and/or technologies (for example Wi-Fi) is also possible. This requires the additional installation of a controller in each supply circuit distribution box. As a consequence of using this technology, it will be necessary to ensure the electrical supply of these controllers and respective flow meters in each of the distribution boxes.

In each distribution box (2010, 2020, 2030) one flow meter (11) per branch should be placed, resulting in a total of fourteen flow meters for the reference house. A detailed diagram of the location of the flow meters (11) inside the distribution boxes is illustrated in FIG. 3. The use of a smaller number of flow meters per junction box requires greater capacity of the reference flow rate of the flow meter used.

Regarding the flow rate measurement sensor (11), i.e., the flow meter, and in one of the preferred embodiments, it comprises the use of turbine flow meters in order to guarantee the measurement of flow rates up to 30 L/min, thus complying with the requirements of the aforementioned dispensers. Turbine flow meters work by measuring the rotation speed of a turbine rotor as the fluid passes through. As the liquid passes through the turbine, the blades are driven. The turbine rotor speed is approximately proportional to the speed of the fluid passing through the turbine. For the measurement of rotational speed, Hall effect or optical sensors are normally used, resulting in a pulsed analogue signal, where each pulse corresponds to a volume unit in the flow meter. By calculating the frequency of the pulsed signal, it is possible to calculate the instantaneous flow rate.

Regarding the controllers (21) used in the system, in one of the preferred embodiments, they comprise the use of 32-bit microcontrollers, USB inputs for communication and programming, analogue signal inputs, digital signal inputs and wireless communication. This type of 32-bit microcontroller allows the simultaneous measurement of 16 different analogue signals, resulting in the use of up to 16 flow meters (11). It also allows connection to a storage module, in which a memory card can be incorporated to store the data acquired by the affected flow rate sensors.

To access the information acquired and stored by the controller (21), in one of the proposed embodiments, an LCD type touch screen is used, which is directly connected to the controller. Through the screen, the user will be able to monitor the real-time consumption of each dispenser, as well as analyse the cumulative consumption considered in the controller programming. Another possible mode of interaction with the user can be performed through a local server (31), using the wireless communication functionality of the chosen controller. This server, programmed into the house's internal network, allows access to data through a mobile application.

One of the variants of the first solution presented refers to the particular situation of having a single system monitoring and control device (20), which is outside the spaces where there are water dispensers, i.e., WCs (202, 203) and kitchen (201). For the user to view the consumption of all rooms in real time—for example in the kitchen sink—it will be necessary to include additional monitoring screens in the system. Under these conditions, a possible configuration involves using a screen for each of the rooms where there are water dispensers. Thus, maintaining the possibility of monitoring consumption in a room where there is no water consumption, the total number of LCD screens would be four.

In addition to the first solution presented, the inclusion of solenoid valves and pressure sensors downstream of the house's entrance meter (19) makes it possible to monitor leaks and interrupt the water supply. Naturally, the supply interruption is also available at the user's request.

FIG. 1 illustrates one of the preferred embodiments of the present invention, which comprises the use of a set of flow meters (11) installed in the water distribution network to monitor the inlets (10) of each of the divisions of the installations to be monitored. The flow meters (11) will make available to a control unit (20) the collected data and/or analogue signals (15). The control unit (20) comprises at least one microcontroller (21), configured to acquire and process data from the flow meters (11) installed in the distribution network, and an AC-DC current converter (22) configured for converting electrical energy from a network supply point (23), converting it from alternating current into direct current, to guarantee the energy supply of the unit (20). Additionally, the output values (30), coming from the control system (20), and displayed for example to a user, will be shared with a server (31), located preferably remotely, and in a preferred way through a wireless connection (25). The output values (30) can be displayed to said user through a screen (32).

FIG. 2 illustrates a particular case of implementation of the system proposed for the present invention, and which aims to clarify the application of the present system in a house. Thus, each room comprising supply taps (18) will require the installation of supervision and control mechanisms, namely in the kitchen (201), in the auxiliary bathroom (202) and in the complete bathroom (203). More specifically, and in the illustration supported by FIG. 2, the kitchen (201) comprises a distribution box C (2010) which guarantees the distribution of the cold water network (16) and hot water (17) by the respective existing taps (18), and which supply the existing appliances therein, such as a washing machine (2011), a dishwasher (2012) or a sink. The auxiliary bathroom (202) comprises a distribution box B (2020) which guarantees the distribution of the cold water (16) and hot water (17) network to the respective existing taps (18), which serve, for example, the flushing cistern or washbasin. Similarly, the complete bathroom (203) comprises a distribution box A (2030) which guarantees the distribution of the cold water network (16) and hot water (17) by the respective existing taps (18), which are useful for example for the flushing cistern, washbasin, bidet and bathtub. The cold water network (16) is monitored in terms of consumption at the entrance to the house by a water meter (19), and its availability is also controlled by means of a tap (18). The cold water network (16) also supplies a device responsible for heating the water, which will subsequently ensure the supply of said hot water network (17).

In the immediate vicinity of the installations to be monitored (201, 202, 203), a control area (20) will be made available to the user that will communicate with the distribution boxes (2010, 2020, 2030) through an analogue signal distribution network (15). The control zone (20) comprises at least one microcontroller (21) and an alternating current to direct current converter (22) connected to an electrical power distribution point (23), which ensures the power supply and operability of the respective controller (21).

In the particular case of FIG. 3, the flow meters are installed independently in each of the service pipes of each of the rooms to be monitored. Thus, the kitchen (201) comprises a distribution box C (2010) configured to receive a hot water service pipe (17) and a cold water service pipe (16) and provide at least one hot water service pipe (17) and three cold water service pipes (16), each of said service pipes (16, 17) comprising a flow meter (11) configured to monitor and measure the amount of water provided by each of said distribution service pipes. The same can be seen in the other divisions, as is the particular case of the auxiliary bathroom (202) and complete bathroom (203). The auxiliary bathroom (202) will comprise a distribution box B (2020) configured to receive a hot water service pipe (17) and a cold water service pipe (16) and provide at least one hot water service pipe (17) and two cold water service pipes (16), each service pipe comprising an independent flow meter. Similarly, the complete bathroom (203) also comprising a distribution box A (2030) configured to receive a hot water service pipe (17) and a cold water service pipe (16), provides at least three water hot water service pipes (17) and four cold water service pipes (16), each of said service pipes comprising an independent flow meter for counting the water provided to each equipment.

In a complementary embodiment of the present invention, and as illustrated in FIG. 4, the monitoring system comprises only the use of flow meters in each of the supply service pipes of the distribution boxes (2010, 2020, 2030) present in each of the rooms to be monitored, in this particular case, in the kitchen (201), in the auxiliary bathroom (202) and in the complete bathroom (203). That is, the distribution box C (2010) will comprise only one flow meter (11) in the main cold water distribution service pipe (16) and one flow meter (11) in the main hot water distribution service pipe (17). Similarly, the distribution box B (2020) will only comprise a flow meter (11) in the main cold water distribution service pipe (16) and a flow meter (11) in the main hot water distribution service pipe (17). Finally, the distribution box A (2030) will only comprise a flow meter (11) in the main cold water distribution service pipe (16) and a flow meter (11) in the main hot water distribution service pipe (17).

The illustration supported by FIG. 5 turns out to be a preferred way of implementing the scheme proposed in FIG. 2. Instead of the control zone (20) being directly connected to each distribution box (2010, 2020, 2030) of the water network, each of said boxes (2010, 2020, 2030) will be independently connected to an assembly formed by the control zone (21), AC-DC converter (22) and power grid supply point (23). Thus, each of these previously mentioned assemblies communicate directly and independently with each distribution box, adding only information regarding the box to which they are connected through a network of analogue signals (15). In addition to the fact that said sets of modules allow the availability and configuration of the respective data acquisition, they also allow the provision of information centralizing elements, such as a global information centralization area (20). Despite being a more decentralized solution in terms of monitoring, it requires, however, the use of a greater number of monitoring components, namely microcontrollers (21) and current converters (22).

The second solution for the presented system comprises the installation of a flow meter (11) and a pressure transducer (12) in the supply pipe of the service pipe to be controlled. To control all consumption in the house, said sensors can be mounted immediately downstream of the main water meter (19) of the house. This solution includes devices related to measuring consumption and others related to the user interface. In devices related to consumption measurement, this proposed approach considers the use of at least:
a flow meter (11), for measuring the instantaneous flow rate of water;
a pressure transducer (12), for the identification of the active dispenser;
a microcontroller (21) for the acquisition, interpretation and processing of data obtained by the flow meter (11) and pressure transducer (12);
an electrical current converter (22) for powering the microcontroller (21) and both sensors (11, 12).

The monitoring devices can be placed in any location of the house, as the communication with the measuring device will now be carried out using wireless networks (25). The monitoring device assembly for this solution will consist of at least:
a microcontroller (33);
a touch screen, for data monitoring;
an electrical current converter (34) to supply the microcontroller (33) and the touch LCD screen.

As in the previously proposed solution, the microcontroller of the measuring device (21) communicates by means of wireless networks with a local server (31) where the acquired data will be stored, which can be accessed through a mobile application installed n a user equipment, e.g., a smartphone, thus allowing interaction with the user. Briefly, and illustrated in FIG. 6, the measuring devices (101) comprise the use of a measuring device assembly, namely at least one flow meter (11) and a pressure transducer (12) that monitor and provide data from the water supply network, making said information available to a control system (20) by means of an analogue data communication system (15), said control system (20) comprising at least one microcontroller (21) configured to process said data, and which is electrically powered from the mains (23) by means of an electrical current converter (22). In turn, the control system (20) will communicate with a monitoring device (102) ideally by means of a wireless data transmission network (25), comprising at least one data server (31), and additionally with an assembly comprising an LCD screen (32) for displaying the data to the user, a microcontroller (33), as well as an AC-DC electric current converter (34) configured to ensure the power supply of said device.

This second solution makes it possible to monitor individual, general or cumulative consumption for a given period in real time. FIG. 7 illustrates the electrical and wireless connections between the components of the second proposed solution. In this embodiment of the developed system, water consumption in the distribution network will produce different pressure variations in each dispenser during its use, mainly detectable during the opening of the valve(s) (18) related to this dispenser. This phenomenon is designated the pressure signature of an equipment. The part of the pressure signature containing more information normally corresponds to a very short period, so it will be necessary to use pressure transducers (12) with high response. The control and monitoring software used in the controller (21) allows the identification of said pressure variations and the correlation with the signatures of each dispenser using artificial intelligence algorithms. Due to the nature of the pressure signature phenomenon, it can be said that the identification of active dispensers at each moment is significantly improved through the use of several pressure sensors, strategically placed in the hydraulic installation of the house. Thus, and in a summarized way supported by the illustration of FIG. 7, the complementary way of monitoring the water supply network will then be guaranteed by the combination of elements comprising the use of at least one measuring device assembly (101) and at least a monitoring device assembly (102). It should be noted that in the present proposed embodiment, the measuring device (101), comprising at least one flow meter (11) and a pressure transducer (12), is installed on the distribution service pipe of the cold water network (16) right after the water meter (19) and downstream of the mains supply.

In the present solution the monitoring device (102) can be placed in any location. Both the flow meter (11) and the pressure transducer (12) need to be connected to the microcontroller of the control device (20). However, this solution does not require running cables between the two devices, as they can communicate over wireless networks. However, it is necessary to provide electrical power for the devices related to the measurement. One of the preferred ways of carrying out the second solution of the system contemplates the installation of a single flow meter (11) in the house supply pipe. Therefore, it is necessary to take into account that more than one dispenser can be active at the same time, thus increasing the flow rate to be monitored. For this particular case, a turbine flow meter capable of measuring up to 75 L/min is used. This flow meter (11) allows the flow rate measurement when five taps, a flushing cistern, a dishwasher, a washing machine and a bathtub are being used simultaneously. With regard to the pressure measurement sensor (12), and for the particular application in question, the main feature to consider is the response time, which must be compatible with the identification of the pressure signatures of the various dispensers. The inclusion of an solenoid valve downstream of the water meter (19) of the house allows the interruption of the water supply at the request of the user or in case of identification of leaks; in this solution, identifiable by the pressure variation when the solenoid valve is closed.

In one of the preferred embodiments proposed for the combined flow meter (11), and considering its use in infrastructures comprising the passage of reduced flow rates, the pressure difference between the water inlet of the combined flow meter (110) and the water outlet of the combined flow meter (119) of the combined flow meter is small. Under these conditions, the force exerted by the spring included in the non-return valve (1119), guarantees and prevents the occurrence of flow in the flow meter (1110) installed in the first service pipe (111). Thus, the flow measured in the flow meter (1120) installed in the second service pipe (112) corresponds to the resulting flow rate measured by the combined flow meter (11).

Supported by the schematic illustration of the operation of FIG. 8, an increase in the inlet flow rate of the combined flow meter (11) tends to increase the pressure difference between the inlet (110) and the outlet (119), which will potentiate the opening of the non-return valve (1119), a circumstance that will result in a flow rate measured and made available by reading the combined flow meter (11) resulting from the sum of the values measured by each of the two internal flow meters (1110, 1120), the flow meter (1110) of the first service pipe (111) and the flow meter (1120) of the second service pipe (112).

For the proper functioning of the combined flow meter (11), the operational characteristics of the two service pipes (111, 112) must ensure that the maximum flow rate limits in each of the two internal flow meters occur at the same pressure difference between the inlet (110) and the outlet (119). In this context, it is important to configure the diameters and lengths of the passage channels in each of the reading service pipes. In some circumstances, it may be convenient to use concentrated pressure drops in the circuit to ensure said operation. However, with the appropriate choice of fluid passage sections in each of the service pipes, it may lead to the waiver of the use of concentrated pressure drops. For the combined flow meter (11) to work properly, it must also be ensured that, to open the non-return valve, in this particular case, the valve (119), the flow rate in the corresponding service pipe must be greater than the minimum flow rate of the flow meter (1110) installed in said service pipe (111). In this way, flow rate values not accounted for in the combined flow meter (11) are avoided.

Fundamental for the correct operation of the combined flow meter (11) is the existence of a pressure drop in the service pipe (111) of the flow meter (1110) which tends to infinity when the pressure difference is small. Whatever device is used to ensure this purpose, it must have a hysteresis cycle on opening and closing. In this way, intermittent operations are avoided when the flow rate is close to that which potentiates the discontinuity in the pressure drop. This hysteresis cycle tends to happen naturally, however with the appropriate choices its effect can be enhanced.

In one of the preferred embodiments of the combined flow meter (11), supported by the illustration in FIG. 8, at least two flow meters (1110, 1120) are used, one in each of the at least two existing service pipes (111, 112). However, the described concept can be generalized to the use of a number of flow meters greater than that shown in the referred figure, as well as the number of service pipes. As previously described in the case studied, and considering the use of a higher number of flow meters implemented in parallel in independent service pipes, in this implementation there should also be small overlaps in the measurement intervals of the successive flow meters. In order to enhance the use of the combined flow meter (11) in large measurement intervals, it is important to use internal flow meters whose measurement intervals are dimensioned in a reading scale in relation to each other.

FIG. 9 illustrates an example of application of the concept disclosed herein and which considers in this particular case the use of three internal flow meters (1110, 1120, 1130) installed independently in adjacent service pipes, in this particular case, the first service pipe (111), the second service pipe (112) and the third service pipe (113). In this form of implementation of the present invention, two independent pressure drops are used, one in each of the two service pipes with greater flow rate, in this case in the first service pipe (111) and in the second service pipe (112). These pressure drops, combined with the remaining characteristics of the circuit, must be chosen so that the maximum flow rates in each of the related internal flow meters occur for the same pressure difference between the inlet (110) and the outlet (119)—similarly to what is seen in the case previously studied for the composition with only two flow meters arranged in adjacent service pipes. The characteristics of the two non-return valves used (1119, 1129) must ensure that the opening of the first valve (1119) occurs for a pressure difference greater than that of the second valve (1129). In this way, it is ensured that the first interior flow meter (1110) is “requested” only for higher flow rates than the others.

To increase the robustness of the measurement, several internal flow meters can also be used in each service pipe. Under these conditions, the resulting flow rate in each service pipe will be obtained by averaging the values obtained in the corresponding internal flow meters installed in that service pipe. In case of inconsistency in the values measured on the referred flow meters of that service pipe, the flow rate in that service pipe can be established ignoring measurements of some of the flow meters whose values deviate from the others, that is, that comprise reading errors greater than the generality of the readings of the other flow meters of that service pipe. The use of several internal flow meters in the same service pipe can be particularly useful in applications where flow rate information is critical, and in particular that require high levels of accuracy. In FIG. 10 the present embodiment is illustrated, wherein the use of more than one internal flow meter per service pipe is proposed, in particular in service pipes (111, 113). Considering that the first service pipe (111) is the one where the flow rate is greater, it can be inferred that the combined flow meter illustrated in FIG. 10 presents greater robustness both in measuring large flow rates, the first service pipe (111) with two flow meters (1110, 1111), and also in measuring small flow rates, third service pipe (113) with three flow meters (1130, 1131, 1132).

The architecture disclosed herein for implementing a combined flow meter is based on the use of internal turbine flow meters. However, the art developed is equally applicable to other types of flow meters, such as those with ultrasonic and electromagnetic technology, among others. It is also possible to use, in the various independent service pipes of the combined flow meter, internal flow meters arranged in series with different technologies and operating principles, to improve the results and accuracy of the readings obtained.

The present description is of course in no way restricted to the embodiments presented herein and a person of ordinary skill in the art may provide many possibilities of modifying it without departing from the general idea as defined in the claims. The preferred embodiments described above are obviously combinable with each other. The following claims further define preferred embodiments.

1. A system for monitoring and managing water consumption in interior house supply networks, comprising
at least one flow meter installed in the interior water supply network; and
at least one control system configured to receive data from the at least one flow meter;
wherein the control system transmits to a server by means of a wireless communication system the data received from the at least one flow meter and also displays them to a user by means of an LCD screen.

2. The system according to claim 1, wherein the control system comprises at least one microcontroller and a current converter.

3. The system according to claim 1, wherein the interior house water supply network comprises at least one room equipped with a distribution box that branches the interior supply network through a set of valves.

4. The system according to claim 1, wherein the interior house water supply network comprises at least one cold water network and one hot water network.

5. The system according to claim 1, wherein the branching of the interior supply network through a set of valves comprises circuits that independently feed each of said valves and that comprise the installation of at least a flow meter in each of said circuits.

6. The system according to claim 1, wherein each distribution box comprises at its inlet at least one cold water network and at least one hot water network under which flow meters are individually installed.

7. The system according to claim 1, wherein each of the distribution boxes comprises decentralized control assemblies comprising at least one microcontroller configured to collect and analyse data from at least one flow meter.

8. The system according to claim 1, wherein the decentralized control assemblies communicate remotely with the control system by means of a wireless communication system.

9. The system according to claim 1, further comprising a measuring device comprising a flow meter and a pressure transducer, which are internally connected to a microcontroller configured to collect and analyse the data coming therefrom.

10. The system according to claim 1, further comprising a monitoring device consisting of a server configured to collect, by means of wireless communication networks, data from a measuring device, and by at least one configured microcontroller and an LCD screen configured to display the information to a user.

11. The system according to claim 10, wherein the server is configured to provide information to a user by means of a user device, for example, a smartphone or other technically suitable device.

12. The system according to claim 1, wherein the flow meter comprises at least two inner service pipes, a first service pipe and a second service pipe, under which they are installed independently, and in each of said service pipes, at least one interior flow meter.

13. The system according to claim 12, wherein the at least two inner service pipes of the flow meter comprise equal sections.

14. The system according to claim 12, wherein the at least two inner service pipes of the flow meter comprise different sections.

15. The system according to claim 12, wherein at least one of the two inner service pipes of the flow meter comprises a non-return valve configured to prevent the occurrence of flow in the flow meter installed in series in the respective service pipe.

16. The system according to claim 12, wherein at least one of the two inner service pipes of the flow meter comprises more than one flow meter mounted in series on the service pipe.
